(19) United States
(12) Patent Application Publication
(10) Pub. No.: US 2005/0039374 A1
(43) Pub. Date: Feb. 24, 2005

(54) Modular fishing lure

(76) Inventor: Herbert Reed, Southington, CT (US)

Correspondence Address: Timothy A. Johnson;McCormick, Paulding & Huber LLP, 185 Asylum Street, CityPlace II, Hartford, CT, 06103, US

(21) Appl. No.: 10/645,942

(22) Filed: Aug. 22, 2003

(51) Int. Cl. A01K 85/00

(52) U.S. Cl. 43/42.39

(57) ABSTRACT

According to the present invention, a modular weight for a fishing lure having an overall specific gravity greater than that of water includes a head coupled to a first end of at least one protrusion The protrusion is selectively inserted at least partially into a fishing lure body independent of a fishing line, hook and/or any connecting hardware. During use, at least a portion of the protrusion extends into, and at least a portion of the head extends out from, an exterior surface of the fishing lure body. The resilience of the fishing lure body material tends to maintain the position of the protrusion during use. The modular weight may be selectively removed and repositioned or exchanged for a different modular weight having a different weight, shape or decorative appearance. Multiple weights may be strategically placed in the lure to further alter the lure's movements in water.

### FIELD OF THE INVENTION

The present invention relates to fishing lures in general and to fishing lures having removable weights in particular.

### BACKGROUND OF THE INVENTION

Fishing lures are well known in the art and are used to attract fish. It is desirable to use lures at various depths beneath the surface of the water to effectively attract different types of fish. Therefore, it is advantageous to use lures having different overall weights. While it is possible to use an entirely different lure for fishing at each depth, it is often desirable to be able to selectively vary the overall weight of the same lure.

Prior art weights are either built into the lure or attached to fishing line, hook and/or other fishing hardware. The amount of weight and the placement/distribution of the weight in relation to the lure body affects the manner in which the lure moves in the water and, thus, its fish triggering characteristics.

Therefore, it is desirable to provide an artificial lure having removable, repositionable and/or replaceable weights that overcomes the known shortcomings in the prior art.

### SUMMARY OF THE INVENTION

According to the present invention, a modular weight for a fishing lure includes a head and at least one protrusion. Each protrusion has a length and includes a first end, a second end and a body portion. The head is coupled to the first end of each protrusion. The modular weight has a specific gravity greater than that of water and is sized for lengthwise insertion into a fishing lure body.

According to one aspect of the present invention, a fishing lure includes a fishing lure body having an exterior surface, and a modular weight. The modular weight described above is inserted lengthwise into the fishing lure body such that at least a portion of the protrusion is within the exterior surface of the fishing lure body, and at least a portion of the head extends from the exterior surface of the fishing lure body.

An advantage of the present invention is that the modular weight may be selectively removed from a fishing lure body and replaced by a second modular weight having a different size, shape, decorative appearance or specific gravity.

Another advantage of the present invention is that the removable weight of the resulting lure is independent of the fishing line, hook, and/or other connecting hardware and, therefore, enables the angler to have more flexibility in achieving lifelike movement.

An even further advantage of the present invention is that the removable weights may be strategically positioned by the user in any desired position relative to the fishing lure body in order to achieve desired movement.

### BRIEF DESCRIPTION OF THE DRAWINGS

FIG. 1 is a side view of one embodiment of the present invention modular weight.

FIG. 2 is a side view of another embodiment of the present invention modular weight having a blunt first end and a shaped head.

FIG. 3 is a further embodiment of the present invention modular weight having a decorated head.

FIG. 3A is a perspective view of the present invention modular weight of FIG. 3.

FIG. 4 is an even further embodiment of the present invention, wherein the head is shaped like a diving plate.

FIG. 4A is a perspective view of the present invention modular weight of FIG. 4.

FIG. 4B is a perspective view of the present invention modular weight of FIG. 4, having multiple protrusions and a plastic, semi-transparent diving plate.

FIG. 5 is an even further embodiment of the present invention modular weight, wherein the protrusion includes screw threads.

FIG. 6 is an even further embodiment of the present invention modular weight including multiple protrusions.

FIG. 7 is an even further embodiment of the present invention modular weight, wherein the protrusion is substantially flat.

FIG. 8 is an even further embodiment of present invention modular weight, wherein the protrusion defines at least one aperture.

FIG. 9 is an embodiment of the fishing lure of the present invention in the general shape of a worm.

FIG. 10 is another embodiment of the fishing lure of the present invention in the general shape of a minnow.

FIG. 11 is an even further embodiment of the fishing lure of the present invention showing a fishing lure body having multiple modular weights inserted therein.

FIG. 12 a fishing lure body having an aperture in which a modular weight is selectively inserted.

### DETAILED DESCRIPTION OF THE INVENTION

Referring to FIG. 1, a modular weight 10 includes a head 12 and at least one protrusion 14. Each protrusion 14 has a length 16 and includes a first end 18, a second end 20 and a body portion 22. The head 12 is coupled to the first end 18 of each protrusion 14. The modular weight 10 has an overall specific gravity greater than that of water.

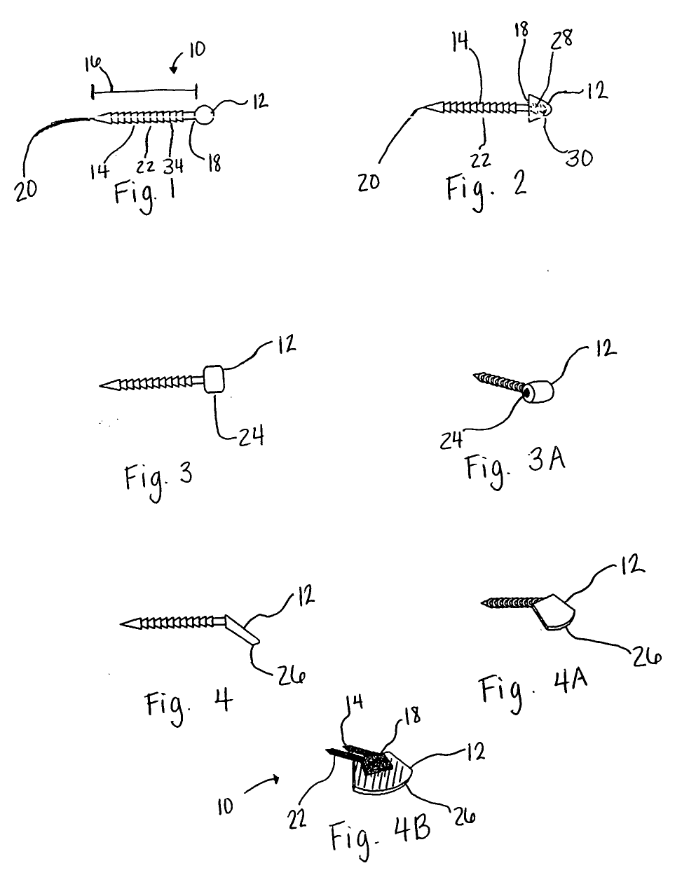

Referring to FIGS. 1 through 4B, the head 12 of each protrusion 14 may be shaped in any desirable manner. For example, as shown in FIGS. 1 and 2, the head 12 may be rounded or spherical. Alternatively, the head 12 may be shaped and decorated to resemble at least one aspect of typical bait (e.g., a minnow head). As shown in FIGS. 3 and 3A, the head 12 may include decorative eyes 24 and various other features that create the appearance of typical bait. In some embodiments, the head 12 may also be shaped to achieve certain movements in the water when the fishing lure in which the modular weight is inserted is pulled. For example, FIGS. 4, 4A and 4B show a head 12 shaped like a diving lip 26 which is operable to force the fishing lure to dive and/or dart in various directions when pulled through the water.

As shown in FIGS. 1, 2 and 4B, the head 12 is coupled to the first end 18 of the protrusion 14. In some embodiments, the head 12 and at least one protrusion 14 may be coupled to one another in such a manner that it is not intended for the two to be separated during normal use. For example, the head 12 and the protrusion 14 in FIG. 1 are fabricated from one unit of common material. Alternatively, the head 12 may be molded onto at least one protrusion 14, as is shown in FIG. 4B. In other embodiments, the head 12 and the protrusion 14 may be separable. For example, as shown in FIG. 2, the protrusion 14 and the head 12 may include complimentary screw threads 28, 30 and are selectively screwed together during use.

Referring to FIGS. 1 and 4B, the head 12 may be made of any suitable material. In some embodiments, the head 12 is made of a material having a specific gravity greater than that of water. Lead, bismuth, tungsten alloys, nickel alloys, steel, brass and ceramics are all known to have particular utility. In addition, and now referring to FIG. 4B, the head 12 may be made of a polymeric material. For example, the head 12 may be made of plastic and molded onto the protrusion 14. Depending on the material and the outer finish, the head 12 may also be reflective (as shown in FIG. 4B) or non-reflective (as shown in FIG. 1), translucent or opaque, depending on the intended end use of the modular weight 10.

Referring to FIGS. 1 and 2, the modular weight 10 includes at least one protrusion 14 that has a length 16 (as shown in FIG. 1) and defines a body portion 22, a first end 18 and a second end 20. Each protrusion is sized to be inserted lengthwise into a fishing lure body (discussed infra.). The second end 20 is preferably pointed, as shown, for example, in FIG. 1, such that the modular weight 10 is operable to selectively pierce an exterior surface of the fishing lure body in which the modular weight 10 is being inserted.

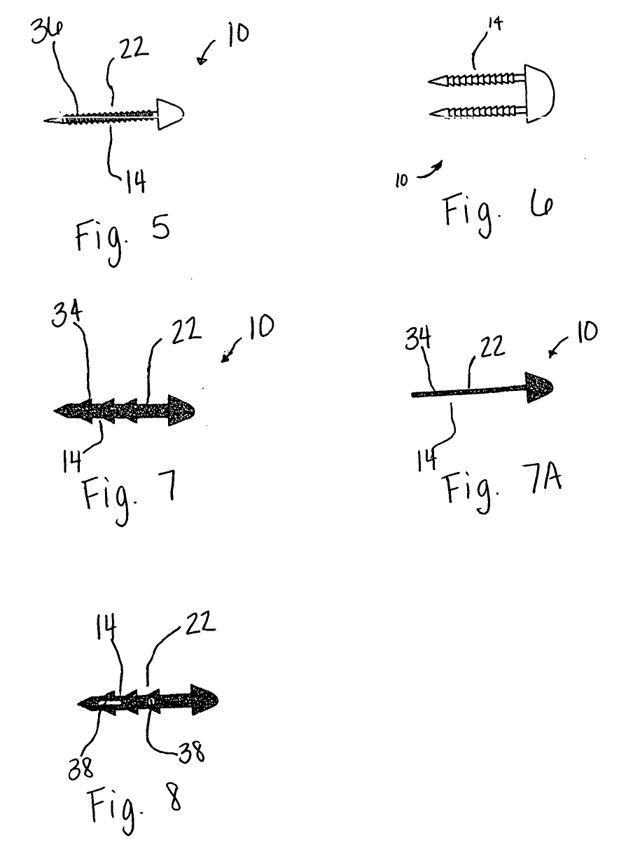

Referring to FIGS. 1, 4B, 5, and 7-7A, the body portion 22 of the protrusion 14 may be substantially round (see, for example, FIG. 1) or flat (see FIGS. 7-7A). In addition, the body portion 22 of the protrusion 14 may be smooth (see FIG. 4B), or contoured. Preferably, the body portion 22 of the protrusion 14 is contoured, which prevents the modular weight 10 from undesirably separating from the fishing lure body during use. For example, the body portion 22 of the protrusion 14 may include at least one rib 34, as shown in FIGS. 1 and 7-7A. In some embodiments, the rib(s) 34 are annular, as shown in FIG. 1, or, in other embodiments, the rib(s) 34 may only extend from one or more sides of the body portion 22 of the protrusion 14 without completely encircling the protrusion 14, as shown in FIGS. 7 and 7A. Alternatively, the body portion 22 of the protrusion 14 may be partially threaded with screw threads 36 to enable the user to more easily insert the modular weight 10 into a fishing lure body by twisting.

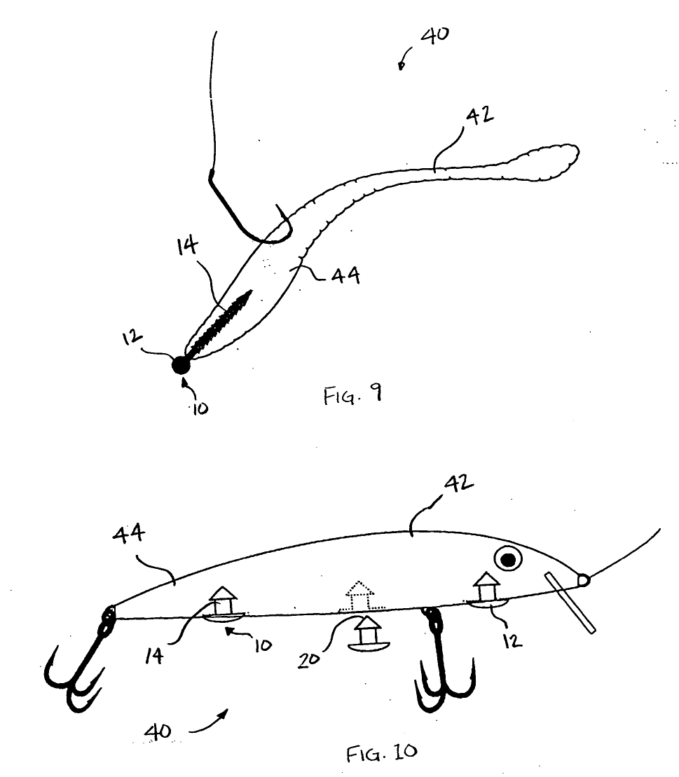

Referring to FIGS. 4B and 6, as mentioned above, in some embodiments, the modular weight 10 includes multiple protrusions 14. Both FIGS. 4B and 6 depict various modular weights 10 having two (2) protrusions 14.

Referring to FIG. 8, in some embodiments, the body portion 22 of the protrusion 14 may include one or more apertures 38. The apertures 38 may be of any suitable shape. For example, FIG. 8 depicts apertures 38 that are both round and oblong.

Each protrusion 14 may be made of any suitable material. Suitable materials include, but are not limited to, lead, bismuth, tungsten alloys, nickel alloys, steel, brass and ceramics. Furthermore, each protrusion 14 may be made of the same or different materials than the material out of which the head 12 or other protrusions 14 (if present) are made.

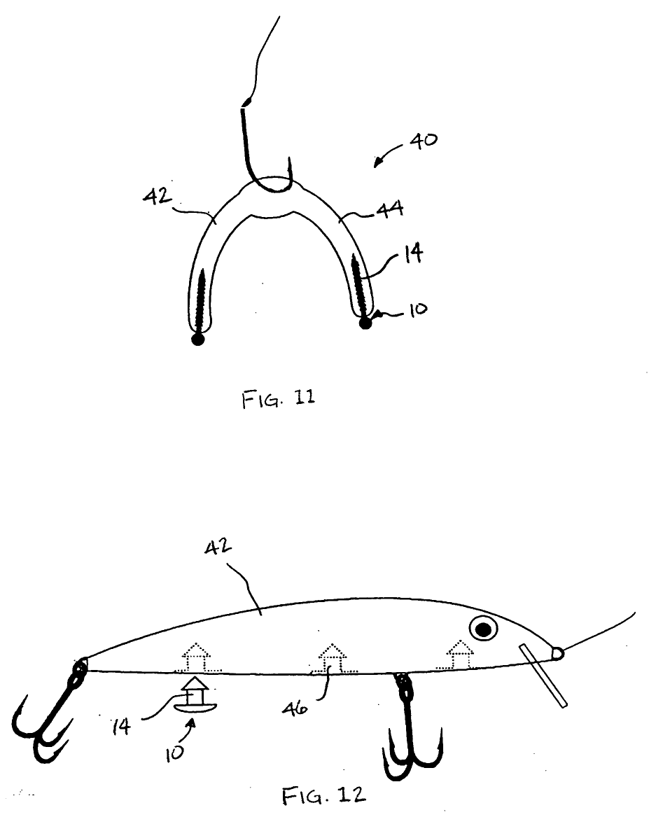

According to another aspect of the invention, and now referring to FIGS. 9-11, a fishing lure 40 includes a modular weight 10, as described above, selectively inserted into a fishing lure body 42. The fishing lure body 42 includes an exterior surface 44. The modular weight 10 is selectively positioned such that at least a portion of one protrusion 14 is inserted within the exterior surface 44 of the fishing lure body 42, and at least a portion of the head 12 extends from the exterior surface 44 of the fishing lure body 42.

The fishing lure body 42 may be made of any suitable material, such as a polymeric material, or wood. However, materials such as vinyl plastisols, latex, and silicone rubber are known to have particular utility. Referring to FIGS. 9 and 10, the fishing lure body 42 may be of any desirable shape, such as, but not limited to, a minnow, a worm or a slug. For example, as shown in FIG. 9, the fishing lure body 42 is shaped similar to a worm and, in FIG. 10, the fishing lure body 42 resembles a minnow.

Referring to FIG. 11, in some embodiments, more than one modular weight 10 may be inserted into the same fishing lure body 42, thereby enabling the user to achieve various desirable movements.

Referring to FIG. 12, in some embodiments, the fishing lure body 42 includes at least one aperture 46 (shown in hidden lines) that extends at least partially through the fishing lure body 42. Preferably, the aperture(s) 46 are sized and shaped to accommodate at least a portion of the protrusion 14 of a modular weight 10. In these embodiments, the modular weight 10 is inserted into the fishing lure body 42 without the need for second end 20 of the protrusion 14 to pierce the exterior surface 44 of the fishing lure body 42 before insertion. For example, apertures 46 are especially useful in lures made of non-resilient material such as, for example, hard woods and polymeric materials.

In operation, the desired modular weight 10, fishing lure body 42 and position of the modular weight 10 relative to the fishing lure body 42 are selected. The second end 20 of the at least one protrusion 14 is inserted into the fishing lure body 42. In some embodiments, the point 32 on the second end 20 of the protrusion 14 is used to pierce through the exterior surface 44 of the fishing lure body 42. The protrusion 14 is inserted at least partially into the fishing lure body 42 independent of a fishing line, hook and/or any connecting hardware. Once in place, the resilience of the material of the fishing lure body 42 tends to maintain the position of the protrusion 14 within the fishing lure body 42, thereby preventing the modular weight 10 from undesirably separating from the fishing lure body 42 during use. When desired, the modular weight 10 may be selectively separated from the fishing lure body 42 by the user and replaced with a second modular weight 10. The second modular weight 10 may be of a different, shape, weight or appearance and may be positioned in a similar or different location as the original modular weight 10.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A modular weight for a fishing lure, comprising:
a head;
at least one protrusion defining a length and having a first end, a second end and a body portion, the first end being coupled to the head;
wherein the at least one protrusion is sized for lengthwise insertion into a fishing lure body independent of a fishing line, hook and/or connecting hardware; and
wherein the at least one protrusion is made of a material having a specific gravity greater than that of water.

2. The modular weight for a fishing lure of claim 1, wherein the head is rounded.

3. The modular weight for a fishing lure of claim 1, wherein the head is spherical.

4. The modular weight for a fishing lure of claim 1, wherein the head is decorated to resemble at least one aspect of typical bait.

5. The modular weight for a fishing lure of claim 4, wherein the head includes decorative eyes.

6. The modular weight for a fishing lure of claim 1, wherein the head is shaped like a diving lip.

7. The modular weight for a fishing lure of claim 1, wherein the head is coupled to the at least one protusion such that the at least one protrusion is not intended to be separated from the head during normal use.

8. The modular weight for a fishing lure of claim 7, wherein the head is fabricated from one unit of common material.

9. The modular weight for a fishing lure of claim 7, wherein the head is molded onto the at least one pro n.

10. The modular weight for a fishing lure of claim 1, wherein the second end of the at least one protrusion is pointed such that the second end is operable to selectively pierce through an exterior surface of a fishing lure body.

11. The modular weight for a fishing lure of claim 1, wherein the body portion of the at least one protrusion is substantially flat.

12. The modular weight for a fishing lure of claim 1, wherein the body portion of the at least one protrusion is substantially round.

13. The modular weight for a fishing lure of claim 1, wherein the body portion of the at least one protrusion is substantially smooth.

14. The modular weight for a fishing lure of claim 1, wherein the body portion of the at least one protrusion is contoured.

15. The modular weight for a fishing lure of claim 14, wherein the body portion of eat least one protrusion includes at least one rib.

16. The modular weight for a fishing lure of claim 14, wherein the body portion of the at least one protrusion is at least partially threaded.

17. The modular weight for a fishing lure of claim 1, wherein the body portion of the at least one protrusion includes at least one aperture.

18. The modular weight for a fishing lure of claim 1, wherein the head and the at least one protrusion are made of different materials.

19. The modular weight for a fishing lure of claim 1, wherein the head and the at least one protrusion are made of substantially the same material.

20. A fishing lure, comprising:
a fishing lure body having an exterior surface;
at least one modular weight having a head, and at least one protrusion having a length, a first end, a second end and a body portion, the first end being coupled to the head;
wherein the at least one modular weight has an overall specific gravity greater than that of water; and
wherein the at least one protrusion is selectively positioned lengthwise in the fishing lure body independent of a fishing line, a hook and/or any connecting hardware such that at least a portion of the at least one protrusion is inserted within the exterior surface of the fishing lure body, and at least a portion of the head extends from the exterior surface of the fishing lure body.

21. The fishing lure of claim 20, wherein the fishing lure body is shaped similar to typical bait.

22. The fishing lure of claim 20, wherein the head is decorated to resemble at least one aspect of typical bait.

23. The fishing lure of claim 20, wherein the head is shaped like a diving lip.

24. The fishing lure of claim 20, wherein the head is coupled to the at least one protrusion such that the at least one protrusion is not intended to be separated from the head during normal use.

25. The fishing lure of claim 24, wherein the head is fabricated from one unit of common material.

26. The fishing lure of claim 24, wherein the head is molded onto the at least one protrusion.

27. The fishing lure of claim 20, wherein the second end of the at least one protrusion is pointed such that the second end is operable to selectively pierce through the exterior surface of the fishing lure body.

28. The fishing lure of claim 20, wherein the body portion of the at least one protrusion is substantially flat.

29. The fishing lure of claim 20, wherein the body portion of eat least one protrusion is substantially round.

30. The fishing lure of claim 20, wherein the body portion of the at least one protrusion is contoured.

31. The fishing lure of claim 30, wherein the body portion of the at least one protrusion includes at least one rib.

32. The fishing lure of claim 30, wherein the body portion of the at least one protrusion is at least partially threaded.
